(19) United States
(12) Patent Application Publication
(10) Pub. No.: US 2023/0278153 A1
(43) Pub. Date: Sep. 7, 2023

(54) POWER TOOLS INCLUDING ELECTRONIC SAFETY MECHANISMS WITH SUPERVISORY CIRCUITS

(71) Applicant: Festool GmbH, Wendlingen am Neckar (DE)

(72) Inventors: Matthias Dennis Kübeler, Kirchheim unter Teck (DE); Ralf Fischer, Remshalden (DE); Dorian Steddin, Ohmden (DE); Philipp Daniel Korhon, Göppingen (DE)

(21) Appl. No.: 18/001,532

(22) PCT Filed: Jun. 24, 2021
(86) PCT No.: PCT/EP2021/067385

§ 371 Date: Dec. 12, 2022

Related U.S. Application Data
(60) Provisional application No. 63/046,960, filed on Jul. 1, 2020.

(51) Int. Cl. B23Q 11/00; B25F 5/02

(52) U.S. Cl. CPC B23Q 11/0092; B25F 5/02

(57) ABSTRACT

Power tools including electronic safety mechanisms with supervisory circuits. The power tools include a motor configured to generate a motive force, an implement holder, and an electronic safety mechanism. The implement holder is configured to receive the motive force from the motor. Receipt of the motive force generates driven motion of the implement holder. The electronic safety mechanism defines a disengaged configuration and an engaged configuration. The electronic safety mechanism includes a detection circuit configured to detect an actuation parameter and to generate a primary trigger signal based, at least in part, on the actuation parameter. The detection circuit also includes a detection circuit controller, which is programmed to control the operation of the detection circuit, and a supervisory circuit, which is configured to verify proper operation of the detection circuit controller.

### RELATED APPLICATION

This application claims priority to U.S. Provisional Patent Application No. 63/046,960, which was filed on Jul. 1, 2020, and the complete disclosure of which is hereby incorporated by reference.

### FIELD OF THE DISCLOSURE

The present disclosure relates generally to power tools with electronic safety mechanisms that include supervisory circuits.

### BACKGROUND OF THE DISCLOSURE

Power tools may utilize an implement to perform an operation on a workpiece. The implement can, in some instances, represent a safety hazard to a user of the power tool. Some power tools include guards and/or other mechanisms to protect the user. However, it still may be desirable to have secondary and/or additional safety mechanisms in place. Some such secondary and/or additional safety mechanisms have been developed for some power tools; however, they often are specific to a particular type of power tool and/or are one-time-use safety mechanisms that may be destructive to the power tool and/or to at least one component of the safety mechanism. Additionally, or alternatively, known secondary and/or additional safety mechanisms may not function if a controller of the safety mechanism fails. Thus, there exists a need for power tools including electronic safety mechanisms with supervisory circuits.

### SUMMARY OF THE DISCLOSURE

Power tools including electronic safety mechanisms with supervisory circuits. The power tools include a motor configured to generate a motive force, an implement holder, and an electronic safety mechanism. The implement holder is configured to operatively attach an implement to the power tool and to receive the motive force from the motor. Receipt of the motive force generates driven motion of the implement holder, and the implement is operatively attached to the power tool via the implement holder such that driven motion of the implement holder generates driven motion of the implement to perform an operation on a workpiece. The electronic safety mechanism defines a disengaged configuration, in which the electronic safety mechanism permits driven motion of the implement holder, and an engaged configuration, in which the electronic safety mechanism resists driven motion of the implement holder. The electronic safety mechanism includes a detection circuit configured to detect an actuation parameter and to generate a primary trigger signal based, at least in part, on the actuation parameter. The electronic safety mechanism is configured to transition from the disengaged configuration to the engaged configuration responsive to generation of the primary trigger signal. The detection circuit also includes a detection circuit controller, which is programmed to control the operation of the detection circuit, and a supervisory circuit, which is configured to verify proper operation of the detection circuit controller.

### BRIEF DESCRIPTION OF THE DRAWINGS

FIG. 1 is a schematic illustration of examples of power tools that include a supervisory circuit, according to the present disclosure.

FIG. 2 is a schematic illustration of examples of power tools that include a supervisory circuit, according to the present disclosure.

FIG. 3 is a schematic illustration of examples of a detection circuit that includes a supervisory circuit and that may be utilized with power tools, according to the present disclosure.

FIG. 4 is a schematic illustration of examples of a reaction circuit that may be triggered by a detection circuit and that may be utilized with power tools, according to the present disclosure.

### DETAILED DESCRIPTION AND BEST MODE OF THE DISCLOSURE

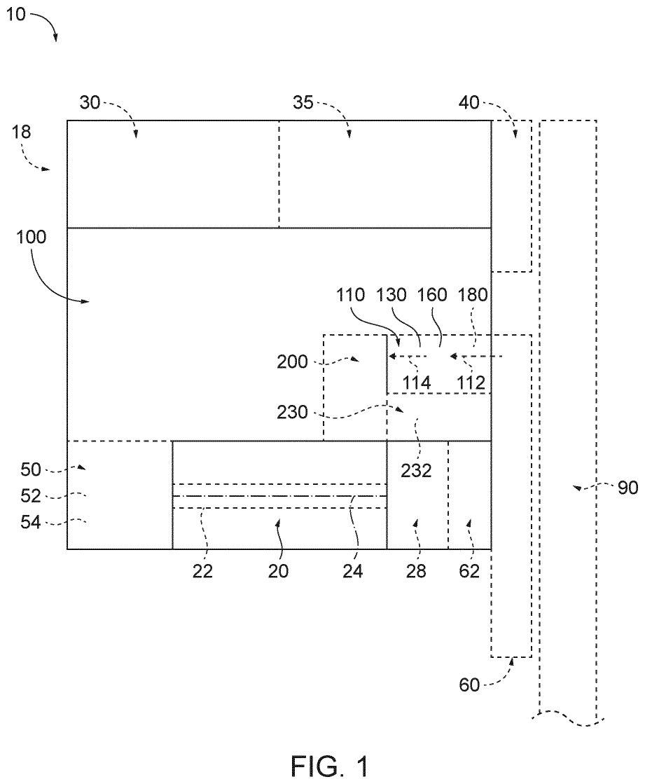

FIGS. 1-4 provide examples of power tools 10, of electronic safety mechanisms 100 that include supervisory circuits 160, and/or of components thereof, according to the present disclosure. Elements that serve a similar, or at least substantially similar, purpose are labeled with like numbers in each of FIGS. 1-4, and these elements may not be discussed in detail herein with reference to each of FIGS. 1-4. Similarly, all elements may not be labeled in each of FIGS. 1-4, but reference numerals associated therewith may be utilized herein for consistency. Elements, components, and/or features that are discussed herein with reference to one or more of FIGS. 1-4 may be included in and/or utilized with any of FIGS. 1-4 without departing from the scope of the present disclosure.

In general, elements that are likely to be included in a particular embodiment are illustrated in solid lines, while elements that are optional are illustrated in dashed lines. However, elements that are shown in solid lines may not be essential to all embodiments and, in some embodiments, may be omitted without departing from the scope of the present disclosure.

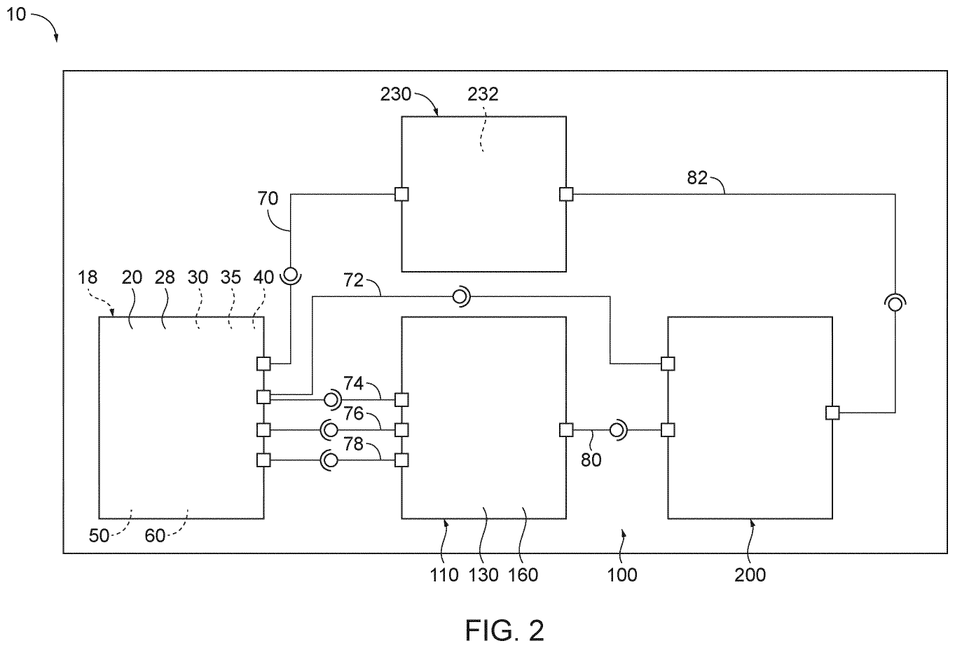

FIGS. 1-2 are schematic illustrations of examples of power tools 10 that include a supervisory circuit 160, according to the present disclosure. Power tools 10 include a motor 20, an implement holder 28, and an electronic safety mechanism 100 that includes supervisory circuit 160. Motor 20 may be configured to generate a motive force, such as via rotation of a motor shaft 22 about a shaft rotational axis 24, as illustrated in FIG. 1. Implement holder 28 is configured to operatively attach an implement 60 to the power tools and/or to receive the motive force from motor 20. Receipt of the motive force may cause and/or generate motion, or driven motion, of implement holder 28, and the driven motion of the implement holder generates motion, or driven motion, of the implement, which may permit the implement to perform an operation on, or to, a workpiece 90, as illustrated in FIG. 1.

Examples of power tools 10 include a saw, a rotary cutting tool, a fastening tool, a reciprocating tool, a vibratory tool, a woodworking tool, a metalworking tool, and/or an automotive tool. Examples of the saw include a handheld circular saw, a miter saw, a radial arm saw, a table saw, a chop saw, a plunge saw, a track saw, a bevel saw, a bandsaw, a jigsaw, an up-cut saw, and/or a panel saw. Examples of a rotary cutting tool include a router, a planer, a joiner, a sander, a drill, and/or a grinder. Examples of a fastening tool include a driver, a ratchet, and/or an impact driver. Examples of a reciprocating tool include a jigsaw and/or a reciprocating saw. Examples of the vibratory tool include a sanding tool and/or a multi-tool. Examples of the operation include cutting, sawing, grinding, rotating, drilling, and/or fastening the workpiece. Examples of workpiece 90 include material to be cut, material to be removed, material to be drilled, a bolt, a screw, and/or a nut. Workpiece 90 may be formed from any suitable material and/or materials, examples of which include wood, plastic, metal, and/or composite materials. Examples of implement 60 include any suitable cutting implement, sanding implement, fastener-engaging implement, grinding implement, bit, drill bid, blade, saw blade, circular saw blade, jigsaw blade, bandsaw blade, socket, grinding wheel, and/or sanding pad.

Electronic safety mechanism 100 defines a disengaged configuration, in which the electronic safety mechanism permits the driven motion of implement holder 28, and an engaged configuration, in which the electronic safety mechanism resists and/or stops the driven motion of the implement holder. Stated another way, and when in the disengaged configuration, the electronic safety mechanism may not stop, may not impede, and/or may not hinder the motion, or the driven motion, of the implement holder. In contrast, and when in the engaged configuration, the electronic safety mechanism may stop, may impede, and/or may hinder the motion, or the driven motion, of the implement holder.

The electronic safety mechanism also includes a detection circuit 110. Detection circuit 110 is configured to detect an actuation parameter 112 and to generate a primary trigger signal 114 based, at least in part, on the actuation parameter, as illustrated in FIG. 1. Detection circuit 110 includes a detection circuit controller 130, which is programmed to control the operation of the detection circuit. Detection circuit 110 also includes supervisory circuit 160, which is adapted, configured, designed, constructed, assembled, implemented, fabricated, and/or programmed to verify the proper operation of, to supplement, and/or to supplement the operation of detection circuit controller 130. Stated another way, supervisory circuit 160 may be configured to certify, to establish, and/or to corroborate proper operation of detection circuit controller 130.

During operation of power tools 10, and as discussed in more detail herein, implement 60 may be operatively attached to power tools 10 via implement holder 28, and motor 20 may be utilized to actuate, or to apply the motive force, to the implement via the implement holder. Implement 60 then may be utilized to perform the operation on the workpiece. Prior to and/or during application of the motive force to the implement, electronic safety mechanism 100 may utilize detection circuit 110 to detect actuation parameter 112. If actuation parameter 112 is indicative of an undesired predetermined condition (which is to be avoided by the power tool), electronic safety mechanism 100, detection circuit 110, and/or detection circuit controller 130 thereof may block supply of electric current to motor 20, may generate the primary trigger signal, may transition to the engaged configuration, and/or may remain in the engaged configuration, thereby resisting and/or stopping driven motion of implement holder 28.

Examples of the undesired predetermined condition include an undesired, an unexpected, an unanticipated, an unacceptable, and/or an undesirable event to be avoided with and/or by the power tool. More specific examples of the undesired predetermined condition include a kickback parameter, which may be indicative of a potential for kickback of the power tool, a movement parameter, which may be indicative of an undesired movement of the power tool, and/or a proximity parameter, which may be indicative of a distance between an individual and the implement being less than a threshold distance.

In some examples, detection circuit 110 may be configured to generate the actuation parameter responsive to, or immediately responsive to, contact, or the initiation of contact, between the individual and the implement. In some such examples, the detection circuit may be referred to herein as generating the actuation parameter responsive to the distance between the individual and the implement being negligible and/or zero. In some examples, the detection circuit may be configured to generate the actuation parameter responsive to the distance between the individual and the implement being a small, finite distance. Examples of such small, finite distances include distances of less than 5 millimeters (mm), less than 4 mm, less than 3 mm, less than 2 mm, less than 1 mm, or less than 0.5 mm. In some such examples, the small, finite distance is greater than zero.

When the undesired predetermined condition includes the kickback parameter and/or the movement parameter, detection circuit 110 may include a motion detector configured to detect motion of the power tool. In such a configuration, the kickback parameter and/or the movement parameter may be based upon, or based upon a potential for, undesired motion of the power tool. When the predetermined operational parameter includes the kickback parameter, detection circuit 110 additionally or alternatively may include a load detector configured to detect loading, or binding, of the implement that may be indicative of a kickback condition.

During operation of power tools 10 and/or concurrently with the operation of other components of power tools 10, such as detection circuit 110 and/or detection circuit controller 130, supervisory circuit 160 may monitor and/or verify the proper operation of at least one other component of electronic safety mechanism 100, such as detection circuit controller 130. Supervisory circuit 160 may be configured to restrict or otherwise block supply of electric current to motor 20, to transition electronic safety mechanism 100 to the engaged configuration, or to maintain the electronic safety mechanism in the engaged configuration responsive to detecting and/or determining a fault condition in the at least one other component of the electronic safety mechanism. Stated another way, supervisory circuit 160 may provide at least partially redundant and/or supplemental protection from, and/or avoidance of, the undesired predetermined condition by ensuring and/or verifying that a remainder of electronic safety mechanism 100 and/or of detection circuit 110 thereof is functional, is not in a fault condition, is configured to detect the undesired predetermined condition, and/or is configured to transition from the disengaged configuration to the engaged configuration.

Electronic safety mechanism 100 may include any suitable structure that may be adapted, configured, designed, and/or constructed to define the disengaged configuration, to include detection circuit 110, to detect the actuation parameter, to generate the primary trigger signal, to include the detection circuit controller, and/or to include the supervisory circuit. In some examples, electronic safety mechanism 100 further may include a reaction circuit 200 and/or a mechanical reaction mechanism 230. As discussed in more detail herein, reaction circuit 200 may be adapted, configured, designed, and/or constructed to receive primary trigger signal 114 from detection circuit 110 and/or to generate a transition motive force responsive to receipt of the primary trigger signal. As also discussed in more detail herein, mechanical reaction mechanism 230 may be adapted, configured, designed, and/or constructed to transition the electronic safety mechanism from the disengaged configuration to the engaged configuration responsive to receipt of the transition motive force.

It is within the scope of the present disclosure that one or more components of electronic safety mechanism 100 may include and/or be modular, or plug-and-play, components that may be utilized interchangeably in a variety of, or in a variety of different, power tools 10. Such modular electronic components of electronic safety mechanism 100, when present, additionally or alternatively may be described as utilizing a plurality of modules, which each may have a specific function and/or may be combined to produce and/or generate the electronic safety mechanism within a given power tool. Some such modules may be customized for and/or specific to a given power tool and/or a given class of power tools. Other such modules may be utilized generically in a variety of different power tools.

As an example, detection circuit 110 may include and/or be a modular detection circuit 110 that may be utilized, or that may be suitable to be utilized, with a corresponding variety of different power tools 10, including power tools that utilize different reaction circuits 200 and/or different mechanical reaction mechanisms 230. As another example, reaction circuit 200 may include and/or be a modular reaction circuit 200 that may be utilized, or that may be suitable to be utilized, with a corresponding variety of different power tools 10, including power tools that utilize different detection circuits 110 and/or different mechanical reaction mechanisms 230. As yet another example, mechanical reaction mechanism 230 may include and/or be a modular mechanical reaction mechanism 230 that may be utilized, or that may be suitable to be utilized, with a corresponding variety of different power tools 10. As another example, one or more components of detection circuit 110, reaction circuit 200, and/or mechanical reaction mechanism 230 may be a modular component.

The above-described modularity may permit and/or facilitate development of a variety of different, but partially related and/or partially interchangeable, electronic safety mechanisms for a variety of different power tools 10, thereby decreasing production costs, improving reliability, and/or permitting the inclusion of electronic safety mechanisms 100 in power tools 10 that previously did not, or could not, include conventional electronic safety mechanisms. As an example, a given detection circuit 110 may be utilized with a variety of different reaction circuits 200 and/or mechanical reaction mechanisms 230, thereby permitting the reaction circuits and/or the mechanical reaction mechanisms to be tailored to a given, or to a specific, application.

As a more specific example, and while the given detection circuit might be effective in both a circular saw and a sander, the reaction circuit and/or the mechanical reaction mechanism suitable to cease actuation of a circular saw blade of the circular saw may differ from the reaction circuit and/or the mechanical reaction mechanism suitable to cease actuation of a sanding structure of the sander. As another more specific example, the reaction circuit and/or the mechanical reaction mechanism suitable to cease rotation of a circular saw blade may differ from the reaction circuit and/or the mechanical reaction mechanism suitable to cease movement of a band saw blade, a reciprocating saw blade, and/or the implements of tools that do not utilize a saw blade.

Turning to FIG. 2, power tools 10 may include additional structures and/or connections that may permit and/or facilitate interaction and/or communication among the various components thereof, such as a mechanical assembly 18, which includes at least motor 20 and implement holder 28, electronic safety mechanism 100, and/or mechanical reaction mechanism 230. As an example, mechanical assembly 18 and mechanical reaction mechanism 230 may be associated with an assembly-reaction mechanism interface 70, which may be configured to permit and/or facilitate electrical and/or mechanical interaction between the mechanical assembly and the mechanical reaction mechanism. As a particular example, mechanical reaction mechanism 230 may cease rotation of motor 20 via assembly-reaction mechanism interface 70.

As another example, mechanical assembly 18 and reaction circuit 200 may be associated with an assembly-reaction circuit interface 72, which may be configured to permit and/or facilitate electrical and/or mechanical interaction between the mechanical assembly and the reaction circuit. As a particular example, reaction circuit 200 may detect and/or determine a status of mechanical assembly 18 via assembly-reaction circuit interface 72.

As another example, mechanical assembly 18 and detection circuit 110 may be associated with an assembly-detect circuit power interface 74, which may be configured to permit and/or facilitate transfer of electric current between the mechanical assembly and the detection circuit. As a particular example, detection circuit 110, including detection circuit controller 130 and/or supervisory circuit 160, may be configured to permit operation of mechanical assembly 18, such as to permit rotation of motor 20 and/or to permit supply of electric current to motor 20, responsive to determining that the power tools are ready for operation. Alternatively, detection circuit 110 may be configured to restrict operation of mechanical assembly 18, such as by blocking supply of electric current to motor 20, responsive to determining that the power tools are not ready for operation.

As another example, mechanical assembly 18 and detection circuit 110 may be associated with an implement signal interface 76, which may be configured to convey information regarding the actuation parameter from the mechanical assembly to the detection circuit. As a particular example, detection circuit 110 may include the detection parameter, or any suitable signal that is indicative of the detection parameter, from mechanical assembly 18 via implement signal interface 76.

As another example, mechanical assembly 18 and detection circuit 110 may be associated with an assembly-electronic safety mechanism interface 78, which may be configured to convey additional information between the mechanical assembly and the detection circuit. Examples of the additional information include an on/off state of the power tool, a bypass state of the power tool, a status of the power tool, and/or a motion, an actuation, and/or a rotational frequency of the implement.

As another example, detection circuit 110 and reaction circuit 200 may be associated with a detection-reaction interface 80, which may be configured to permit electrical communication between the detection circuit and the reaction circuit. As a particular example, detection-reaction interface 80 may be configured to convey the primary trigger signal, a secondary trigger signal, and/or status information between the detection circuit and the reaction circuit. As discussed in more detail herein, reaction circuit 200 may be configured to stop actuation of the implement responsive to receipt of the primary trigger signal and/or of the secondary trigger signal.

As another example, reaction circuit 200 and mechanical reaction mechanism 230 may be associated with a circuit-mechanism interface 82, which may be configured to facilitate electrical and/or mechanical communication between the reaction circuit and the mechanical reaction mechanism. As a particular example, and as discussed in more detail herein, reaction circuit 200 may be configured to generate the transition motive force and/or to convey the transition motive force via circuit-mechanism interface 82.

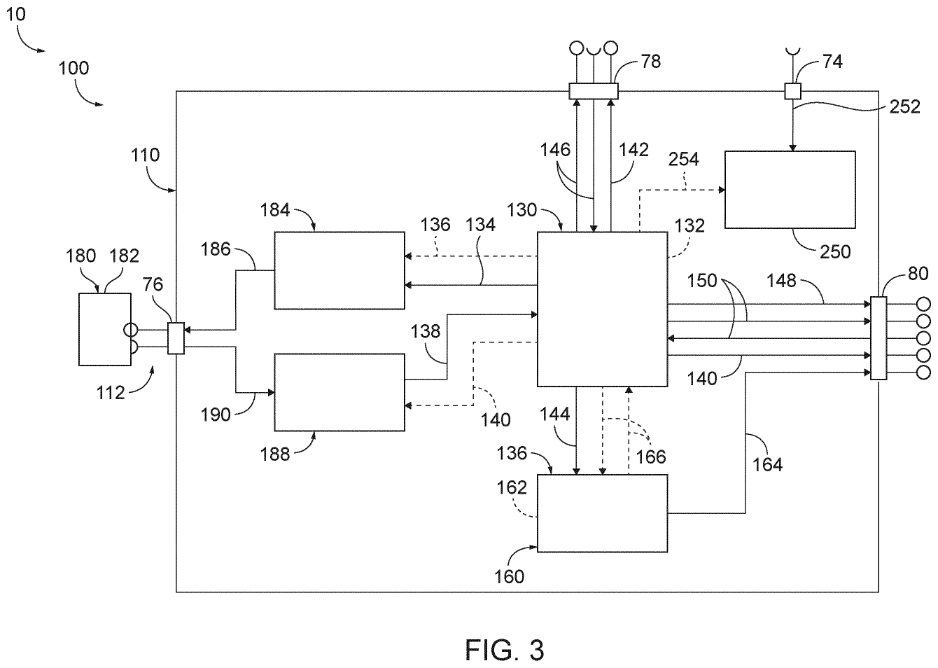

FIG. 3 is a schematic illustration of examples of a detection circuit 110 that includes a supervisory circuit 160 and/or that may be utilized with power tools 10, according to the present disclosure. Detection circuit 110 of FIG. 3 may include and/or be a more detailed illustration of detection circuit 110 of FIGS. 1-2. With this in mind, any of the structures, functions, and/or features disclosed herein with reference to detection circuit 110 of FIG. 3 may be included in and/or utilized with detection circuits 110 of FIGS. 1-2 without departing from the scope of the present disclosure. Similarly, any of the structures, functions, and/or features disclosed herein with reference to detection circuit 110 of FIGS. 1-2 may be included in and/or utilized with detection circuit 110 of FIG. 3 without departing from the scope of the present disclosure. Examples of detection circuit 110 and/or components thereof, as well as examples of power tools 10 and/or other components of electronic safety mechanisms 100, including reaction circuits 200 and mechanical reaction mechanisms 230, are disclosed in U.S. Pat. Nos. 7,536,238, 7,971,613, and 9,724,840 and also in International Patent Application Publication No. WO 2017/0210091, the complete disclosures of which are hereby incorporated by reference.

As discussed, detection circuit 110 may be configured to detect actuation parameter 112. The detection circuit may detect the actuation parameter in any suitable manner and/or utilizing any suitable structure. As an example, detection circuit 110 may include a capacitive sensor assembly 180, which may be configured to detect the actuation parameter. Capacitive sensor assembly 180, when present, may include a capacitive interface 182, a signal drive circuit 184, and a signal sense circuit 188. Signal drive circuit 184 may be configured to provide a drive signal 186 to capacitive interface 182, and signal sense circuit 188 may be configured to receive a sense signal 190 from the capacitive interface. Actuation parameter 112 may be based, at least in part, on the drive signal 186, sense signal 190, and/or a comparison between the drive signal and the sense signal.

The implement, such as implement 60 of FIGS. 1-2, may form a portion of and/or may at least partially define the capacitive interface. As an example, the capacitive interface may include electrically conductive structures separated by a dielectric material, and the implement may form at least a portion of one of the electrically conductive structures.

Detection circuit controller 130 may include any suitable structure that may be adapted, configured, designed, constructed, and/or programmed to control the operation of detection circuit 110. As an example, detection circuit controller 130 may be programmed to provide a drive control signal 134 to the signal drive circuit. In some such examples, the drive control signal may control the operation of signal drive circuit 184 and/or drive signal 186 may be based, at least in part, on the drive control signal.

As another example, detection circuit controller 130 may be programmed to provide a drive diagnostic signal 136 to, or receive the drive diagnostic signal from, the signal drive circuit. In some such examples, detection circuit 110 further may be programmed to utilize the drive diagnostic signal to verify the proper operation of the signal drive circuit. As yet another example, detection circuit controller 130 may be programmed to receive a sense control signal 138 from the signal sense circuit. In some such examples, the actuation parameter may be based, at least in part, on the sense control signal. As another example, detection circuit controller 130 may be programmed to provide a sense diagnostic signal 140 to, or receive the drive diagnostic signal from, the signal sense circuit. In some such examples, the detection circuit further may be programmed to utilize the sense diagnostic signal to verify the proper operation of the signal sense circuit.

As another example, detection circuit controller 130 may be programmed to determine that power tools 10 are in a predetermined operating configuration and to generate a motor engage signal 142 responsive to determining that the power tools are in the predetermined operating configuration. Power tools 10 then may be configured to permit the motor to generate the motive force responsive to generation of the motor engage signal. Examples of the predetermined operating configuration include configurations in which all safety interlocks of the power tools have been satisfied, configurations in which the actuation parameter is not indicative of the undesired predetermined condition, and/or configurations in which the detection circuit controller has not generated, or is not generating, primary trigger signal 114. As another example, detection circuit controller 130 may be programmed to control the operation of supervisory circuit 160, such as via a supervisory circuit control signal 144.

Supervisory circuit 160 may include any suitable structure that may be adapted, configured, designed, constructed, assembled, implemented, fabricated, and/or programmed to verify the proper operation of the at least one other component of detection circuit 110, such as detection circuit controller 130 and/or capacitive sensor assembly 180. As an example, supervisory circuit 160 may be configured to monitor operation of the at least one other component of detection circuit 110 and to generate a secondary trigger signal 164 responsive to determining that the at least one other component of the detection circuit is in a corresponding fault state. Examples of the fault state include an undesired state, an inoperable state, and/or any state in which the at least one other component of the detection circuit is unable to perform, or incapable of performing, in a designed and/or intended manner.

As another example, supervisory circuit 160 may be adapted, configured, designed, constructed, assembled, implemented, fabricated, and/or programmed to verify that a voltage within at least one electrical conductor of power tool 10 is within a threshold voltage range and/or above a threshold minimum voltage. Stated another way, supervisory circuit 160 may be configured to verify that a low voltage, or brownout, condition does not exist within power tool 10.

In a specific example, supervisory circuit 160 may be configured to monitor operation of detection circuit controller 130 and to generate secondary trigger signal 164 responsive to detection of a fault condition in the detection circuit controller. In another specific example, the supervisory circuit may be configured to monitor primary trigger signal 114 and to generate secondary trigger signal 164 responsive to generation of the primary trigger signal. In another specific example, supervisory circuit 160 may be configured to maintain communication with detection circuit controller 130, such as via one or more diagnostic connections 166, and to generate the secondary trigger signal responsive to interruption of the communication, such as for greater than a threshold interruption time. As yet another specific example, supervisory circuit 160 may be programmed to verify that the voltage within the at least one electrical conductor of power tool 10 is within the threshold voltage range and/or above the threshold minimum voltage and to generate the secondary trigger signal responsive to determining that the voltage within the at least one electrical conductor of power tool 10 is outside the threshold voltage range and/or below the threshold minimum voltage.

It is within the scope of the present disclosure that supervisory circuit 160 may be separate from, distinct from, and/or may be formed on a different die from, detection circuit controller 130. As an example, supervisory circuit 160 may be positioned within a supervisory circuit electronic package 162, detection circuit controller 130 may be positioned within a detection circuit controller electronic package 132, and the detection circuit controller electronic package may be separate from, distinct from, and/or spaced apart from the supervisory circuit electronic package. As another example, the supervisory circuit may be a supervisory microcontroller, and the detection circuit controller may be a detection circuit microcontroller that is separate from, distinct from, and/or spaced apart from the supervisory microcontroller. Such a configuration may decrease a potential for failure of electronic safety mechanism 100 due to a failure, or individual failure, of detection circuit controller 130 or supervisory circuit 160. For example, if one of detection circuit controller 130 and supervisory circuit 160 malfunctions, loses electrical power, loses the ability to send or receive communications, and/or is physically damaged, the other of detection circuit controller 130 and supervisory circuit 160 still may remain operational.

Supervisory circuit 160 may include and/or be any suitable structure, electronic structure, and/or electronic package that may be configured to perform the functions disclosed herein. As an example, supervisory circuit 160 may include and/or be a supervisory controller, such as the supervisory microcontroller. In some such examples, supervisory circuit 160 may be referred to herein as being a software-executing supervisory circuit 160 and/or as being a supervisory circuit 160 that is programmable and/or that is configured to execute software commands Such a configuration may provide flexibility in implementation and/or programming of the supervisory controller, may permit periodic updates to the supervisory controller, and/or may permit the supervisory controller to be programmed differently for different power tools 10.

As another example, supervisory circuit 160 may include and/or be a logic circuit, a voltage detection circuit, and/or a frequency detection circuit. In some such examples, supervisory circuit 160 may be referred to herein as being a hardware supervisory circuit 160, as being only a hardware supervisory circuit 160, and/or as being a supervisory circuit 160 that lacks the ability to be programmed and/or to execute software commands. In a specific example, supervisory circuit 160 may include the frequency detection circuit, which may be utilized to detect and/or to verify a heartbeat signal from detection circuit controller 130, such as via diagnostic connection 166. In another specific example, supervisory circuit 160 may include the voltage detection circuit, which may be utilized to detect and/or to verify that the voltage within the at least one electrical conductor of power tool 10, such as diagnostic connection 166, is within the threshold voltage range and/or above the threshold minimum voltage.

With continued reference to FIG. 3, power tools 10 and/or detection circuit 110 may include additional structures and/or connections that may permit and/or facilitate interaction and/or communication among the various components thereof and/or with other components of the power tools. As an example, detection circuit controller 130 may include a serial connection 146 configured for communication with mechanical assembly 18 of FIGS. 1-2 via assembly-electronic safety mechanism interface 78. As another example, detection circuit 110 may include a power supply structure 250, which may be configured to receive an electric current 252 from mechanical assembly 18 via assembly-detect circuit power interface 74, such as to power the detection circuit. As another example, power supply structure 250 may include a diagnostic connection 254 with detection circuit controller 130, which may be utilized to convey diagnostic information between the power supply structure and the detection circuit controller.

As another example, detection circuit controller 130 may include a synchronization connection 148, which may be utilized to synchronize detection circuit controller 130 and reaction circuit 200 via detection-reaction interface 80. As another example, detection circuit controller 130 may include a serial connection 150, which may be configured for communication between detection circuit controller 130 and reaction circuit 200 via detection-reaction interface 80.

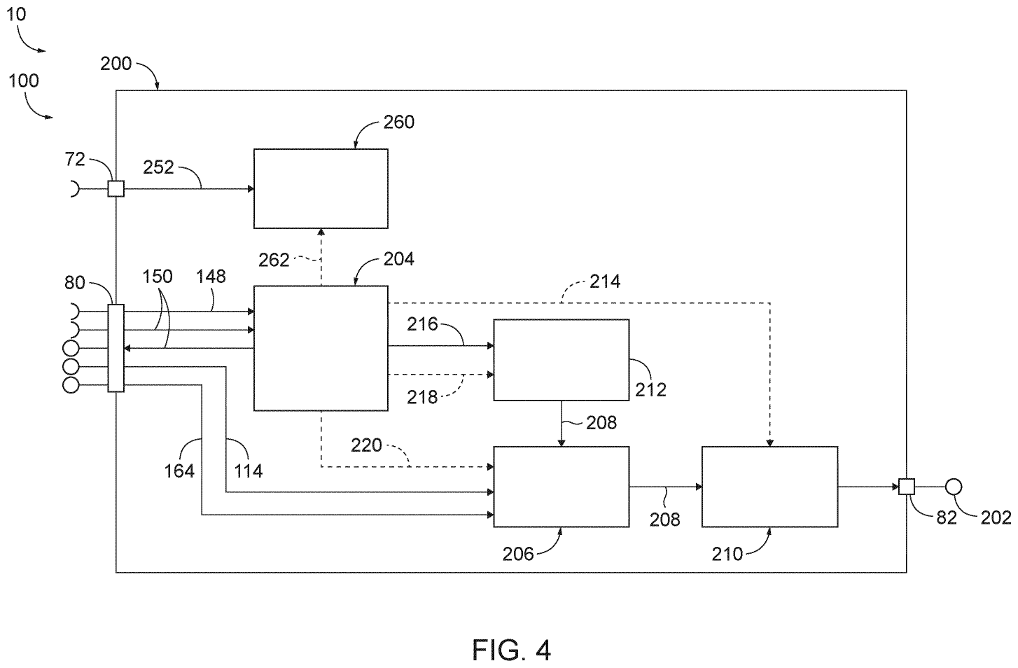

FIG. 4 is a schematic illustration of examples of a reaction circuit 200 that may be triggered by a detection circuit 110 (as illustrated in FIGS. 1-3) and/or that may be utilized with power tools 10, according to the present disclosure. As illustrated in FIG. 4, reaction circuit 200 may include a reaction circuit controller 204, which may be programmed to control the operation of the reaction circuit. As also illustrated in FIG. 4, reaction circuit 200 may include a trigger circuit 206 and an electro-mechanical actuator 210. Trigger circuit 206 may be configured to receive primary trigger signal 114 and/or secondary trigger signal 164 and to provide a trigger electric current 208 to electro-mechanical actuator 210 responsive to receipt of the primary trigger signal and/or of the secondary trigger signal. Electro-mechanical actuator 210 may be configured to generate a transition motive force 202 responsive to receipt of the trigger electric current. An example of electro-mechanical actuator 210 includes a solenoid.

In some examples, reaction circuit 200 may include an electric current source 212. Electric current source 212, when present, may be configured to generate trigger electric current 208 and/or to provide the trigger electric current to trigger circuit 206. An example of electric current source 212 includes an energy storage device, such as a capacitor. Such a configuration may permit and/or facilitate generation of transition motive force 202 even if power tools 10 lose power.

With continued reference to FIG. 4, power tools 10 and/or reaction circuits 200 thereof may include additional structures and/or connections that may permit and/or facilitate interaction and/or communication among the various components thereof and/or with other components of the power tools. As an example, reaction circuits 200 may include a power supply structure 260, which may be configured to receive electric current 252 from mechanical assembly 18 via assembly-reaction circuit interface 72, such as to power the reaction circuit. As another example, power supply structure 260 may include a diagnostic connection 262 with reaction circuit controller 204, which may be utilized to convey diagnostic information between the power supply structure and the reaction circuit controller. As another example, reaction circuit controller 204 may include a diagnostic connection 214 with electro-mechanical actuator 210, which may be utilized to convey diagnostic information between the reaction circuit controller and the electro-mechanical actuator. As another example, reaction circuit controller 204 may include a control connection 216 with electric current source 212, which may be utilized to control the operation of the electric current source. As another example, reaction circuit controller 204 may include a diagnostic connection 218 with electric current source 212, which may be utilized to convey diagnostic information between the reaction circuit controller and the electric current source. As another example, reaction circuit controller 204 may include a diagnostic connection 220 with trigger circuit 206, which may be utilized to convey diagnostic information between the reaction circuit controller and the trigger circuit.

Returning to FIG. 1, mechanical reaction mechanism 230 may include any suitable structure that may be adapted, configured, designed, and/or constructed to transition the electronic safety mechanism from the disengaged configuration to the engaged configuration responsive to receipt of the transition motive force. An example of mechanical reaction mechanism 230 includes a braking assembly 232, which may be configured to stop driven motion of implement holder 28 responsive to receipt of the transition motive force. Examples of the braking assembly 232 include a friction assembly configured to apply a frictional force to stop driven motion of the implement holder, a brake shoe, a brake pad, a brake rotor, and/or a brake caliper.

Motor 20 may include any suitable structure that may provide the motive force for rotation of motor shaft 22 and/or for actuation of implement holder 28. Examples of motor 20 include an electric motor, an AC electric motor, a DC electric motor, a brushless electric motor, a brushless DC electric motor, a variable-speed motor, and/or a single-speed motor.

As illustrated in dashed lines in FIGS. 1-2, power tools 10 may include a gripping region 30. Gripping region 30, when present, also may be referred to herein as, and/or may be, a handle and may be configured to be gripped by a user during use of the power tool.

As also illustrated in dashed lines, power tools 10 may include a switch 35. Switch 35, when present, may be configured to be selectively actuated by the user of the power tools and/or to selectively apply an electric current to motor 20, such as to power motor 20. Examples of switch 35 include an electrical switch, a normally open electrical switch, a momentary electrical switch, and/or a locking momentary electrical switch.

As also illustrated in dashed lines, power tools 10 may include a workpiece support 40. Workpiece support 40, when present, may be configured to support workpiece 90, as illustrated in FIG. 1, and/or to position the power tools relative to the workpiece when the workpiece is cut or otherwise acted upon by the implement. For example, many power tools 10 in the form of saws include workpiece support 40 in the form of a base plate, table, shoe, rack, or pad.

Power tools 10 may include any suitable power source, and corresponding power structures, for powering motor 20 and/or electronic safety mechanism 100. Examples of the power structures include a power supply structure 50, a power cord 52, and/or a battery 54.

As discussed in more detail herein, power tools 10 may include and/or utilize capacitive sensor assemblies 180 that utilize a capacitive coupling with the individual and/or with implement 60. To permit and/or facilitate such a capacitive coupling, power tools 10 may include an implement isolation structure 62, as illustrated in FIG. 1. Implement isolation structure 62, when present, may be adapted, configured, designed, and/or constructed to electrically isolate the implement from at least one other component of the power tools or even from a remainder of the power tools. For example, the implement may be electrically isolated from the powered components of the power tool, or even from the remaining components of the power tool. As another example, implement 60 and implement holder 28 and/or motor shaft 22 to which the implement is coupled may be electrically isolated from the powered components of the power tool, or even from the remaining components of the power tool. Examples of implement isolation structure 62 include an electrically insulating material and/or a dielectric material.

Electronic safety mechanism 100, including detection circuit 110, detection circuit controller 130, supervisory circuit 160, and/or reaction circuit controller 204 thereof, may include and/or be any suitable structure, device, and/or devices that may be adapted, configured, designed, constructed, and/or programmed to perform the functions discussed herein. As examples, electronic safety mechanism 100 may include one or more of an electronic controller, a dedicated controller, a special-purpose controller, a personal computer, a special-purpose computer, a display device, a logic device, a memory device, and/or a memory device having computer-readable storage media.

The computer-readable storage media, when present, also may be referred to herein as non-transitory computer readable storage media. This non-transitory computer readable storage media may include, define, house, and/or store computer-executable instructions, programs, and/or code; and these computer-executable instructions may direct power tools 10, electronic safety mechanisms 100, detection circuit 110, detection circuit controller 130, supervisory circuit 160, and/or reaction circuit controller 204 to perform any suitable portion, or subset, of the functions disclosed herein. Examples of such non-transitory computer-readable storage media include CD-ROMs, disks, hard drives, flash memory, etc. As used herein, storage or memory devices and/or media having computer-executable instructions, as well as computer-implemented methods and other methods according to the present disclosure, are considered to be within the scope of subject matter deemed patentable in accordance with Section 101 of Title 35 of the United States Code.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of power tools according to the present disclosure are presented in the following enumerated paragraphs.

A1. A power tool, comprising:
a motor configured to generate a motive force;
an implement holder configured to operatively attach an implement to the power tool and to receive the motive force from the motor, wherein receipt of the motive force generates driven motion of the implement holder, and further wherein, when the implement is operatively attached to the power tool via the implement holder, the driven motion of the implement holder generates driven motion of the implement to perform an operation on a workpiece; and
an electronic safety mechanism that defines a disengaged configuration, in which the electronic safety mechanism permits the driven motion of the implement holder, and an engaged configuration, in which the electronic safety mechanism resists the driven motion of the implement holder, wherein the electronic safety mechanism includes a detection circuit configured to detect an actuation parameter and to generate a primary trigger signal based, at least in part, on the actuation parameter, wherein the electronic safety mechanism is configured to transition from the disengaged configuration to the engaged configuration responsive to generation of the primary trigger signal, and further wherein the detection circuit includes:
(i) a detection circuit controller, which is programmed to control operation of the detection circuit; and
(ii) a supervisory circuit, which is configured to verify the proper operation of the detection circuit controller.

A2. The power tool of paragraph A1, wherein the electronic safety mechanism further includes:
(i) a reaction circuit configured to receive the primary trigger signal and to generate a transition motive force responsive to receipt of the primary trigger signal; and
(ii) a mechanical reaction mechanism configured to mechanically transition the electronic safety mechanism from the disengaged configuration to the engaged configuration responsive to receipt of the transition motive force.

A3. The power tool of paragraph A2, wherein the reaction circuit is a modular reaction circuit.

A4. The power tool of any of paragraphs A2-A3, wherein the reaction circuit includes a reaction circuit controller programmed to control operation of the reaction circuit.

A5. The power tool of any of paragraphs A2-A4, wherein the reaction circuit includes a trigger circuit and an electro-mechanical actuator, wherein the trigger circuit is configured to receive at least one of the primary trigger signal and a secondary trigger signal and to provide a trigger electric current to the electro-mechanical actuator responsive to receipt of the at least one of the primary trigger signal and the secondary trigger signal.

A6. The power tool of paragraph A5, wherein the electro-mechanical actuator is configured to generate the transition motive force responsive to receipt of the trigger electric current.

A7. The power tool of any of paragraphs A5-A6, wherein the reaction circuit further includes an electric current source configured to generate the trigger electric current and to provide the trigger electric current to the trigger circuit.

A8. The power tool of any of paragraphs A2-A7, wherein the mechanical reaction mechanism includes a braking assembly configured to stop the driven motion of the implement holder responsive to receipt of the transition motive force.

A9. The power tool of paragraph A8, wherein the braking assembly includes at least one of:
(i) a friction assembly configured to apply a frictional force to stop the driven motion of the implement holder;
(ii) a brake shoe;
(iii) a brake pad;
(iv) a brake drum; and
(v) a brake rotor.

A10. The power tool of any of paragraphs A1-A9, wherein the detection circuit is a modular detection circuit.

A11. The power tool of any of paragraphs A1-A10, wherein the detection circuit includes a capacitive sensor assembly configured to detect the actuation parameter.

A12. The power tool of paragraph A11, wherein the capacitive sensor assembly includes a capacitive interface, a signal drive circuit, which is configured to provide a drive signal to the capacitive interface, and a signal sense circuit, which is configured to receive a sense signal from the capacitive interface.

A13. The power tool of paragraph A12, wherein the implement at least partially defines the capacitive interface.

A14. The power tool of any of paragraphs A12-A13, wherein the actuation parameter is based, at least in part, on at least one of:
(i) the drive signal;
(ii) the sense signal; and
(iii) a comparison between the drive signal and the sense signal.

A15. The power tool of any of paragraphs A12-A14, wherein the detection circuit controller is programmed to at least one of:
(i) provide a drive control signal to the signal drive circuit, wherein the drive signal is based, at least in part, on the drive control signal;
(ii) provide a drive diagnostic signal to the signal drive circuit, wherein the detection circuit controller further is programmed to utilize the drive diagnostic signal to verify proper operation of the signal drive circuit;
(iii) receive a sense control signal from the signal sense circuit, wherein the actuation parameter is based, at least in part, on the sense control signal; and
(iv) receive a sense diagnostic signal from the signal sense circuit, wherein the detection circuit further is programmed to utilize the sense diagnostic signal to verify proper operation of the signal sense circuit.

A16. The power tool of any of paragraphs A1-A15, wherein the detection circuit controller is programmed to generate the primary trigger signal when the actuation parameter is indicative of an undesired predetermined condition, optionally wherein the undesired predetermined condition includes at least one of:
(i) an undesired event to be avoided with the power tool;
(ii) a kickback parameter indicative of a potential for kickback of the power tool;
(iii) a movement parameter indicative of an undesired movement of the power tool; and
(iv) a proximity parameter indicative of a distance between an individual and the implement being less than a threshold distance.

A17. The power tool of any of paragraphs A1-A16, wherein the detection circuit controller is programmed to determine that the power tool is in a predetermined operating configuration and to generate a motor engage signal responsive to determining that the power tool is in the predetermined operating configuration, wherein the power tool is configured to permit the motor to generate the motive force responsive to generation of the motor engage signal.

A18. The power tool of any of paragraphs A1-A17, wherein the supervisory circuit is configured to monitor operation of at least one other component of the detection circuit and to generate a/the secondary trigger signal responsive to determining that the at least one other component of the detection circuit is in a corresponding fault state.

A19. The power tool of any of paragraphs A1-A18, wherein the supervisory circuit is configured to monitor operation of the detection circuit controller and to generate a/the secondary trigger signal responsive to detecting a fault in the detection circuit controller.

A20. The power tool of any of paragraphs A1-A19, wherein the supervisory circuit is configured to monitor the primary trigger signal and to generate a/the secondary trigger signal responsive to generation of the primary trigger signal.

A21. The power tool of any of paragraphs A1-A20, wherein the supervisory circuit is configured to maintain communication with the detection circuit controller and to generate a/the secondary trigger signal responsive to interruption of the communication.

A21.1 The power tool of any of paragraphs A1-A21, wherein the supervisory circuit is configured to verify that a voltage within at least one electrical conductor of the power tool is within a threshold voltage range and to generate a/the secondary trigger signal responsive to the voltage within the at least one electrical conductor of the power tool being outside the threshold voltage range.

A22. The power tool of any of paragraphs A1-A21.1, wherein the supervisory circuit is positioned within a supervisory circuit electronic package, and further wherein the detection circuit controller is positioned within a detection circuit controller electronic package that is spaced apart from the supervisory circuit electronic package.

A23. The power tool of any of paragraphs A1-A22, wherein the supervisory circuit includes, or is, a supervisory microcontroller, and further wherein the detection circuit controller is a detection circuit microcontroller that is distinct from the supervisory microcontroller.

A23.1 The power tool of any of paragraphs A1-A23, wherein the supervisory circuit includes, or is, at least one of a logic circuit, a voltage detection circuit, and a frequency detection circuit.

A24. The power tool of any of paragraphs A1-A23.1, wherein the motor includes an electric motor.

A25. The power tool of any of paragraphs A1-A24, wherein the power tool further includes a gripping region configured to be gripped by a user of the power tool during operation of the power tool to perform an/the operation.

A26. The power tool of any of paragraphs A1-A25, wherein the power tool further includes a switch configured to selectively apply an electric current to the motor to initiate generation of the motive force.

A27. The power tool of any of paragraphs A1-A26, wherein the power tool further includes a workpiece support configured to position the workpiece and the power tool relative to one another when the power tool performs the operation.

A28. The power tool of any of paragraphs A1-A27, wherein the power tool further includes at least one of:
(i) a power cord configured to provide a/the electric current to the power tool; and
(ii) a battery configured to provide the electric current to the power tool.

A29. The power tool of any of paragraphs A1-A28, wherein the power tool is at least one of:
(i) a saw;
(ii) a rotary cutting tool;
(iii) a fastening tool;
(iv) a reciprocating tool;
(v) a vibratory tool;
(vi) a woodworking tool;
(vii) a metalworking tool; and
(viii) an automotive tool.

### INDUSTRIAL APPLICABILITY

The power tools disclosed herein are applicable to the power tool industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A power tool, comprising:
a motor configured to generate a motive force;
an implement holder configured to operatively attach an implement to the power tool and to receive the motive force from the motor, wherein receipt of the motive force generates driven motion of the implement holder, and further wherein, when the implement is operatively attached to the power tool via the implement holder, the driven motion of the implement holder generates driven motion of the implement to perform an operation on a workpiece; and
an electronic safety mechanism that defines a disengaged configuration, in which the electronic safety mechanism permits the driven motion of the implement holder, and an engaged configuration, in which the electronic safety mechanism resists the driven motion of the implement holder, wherein the electronic safety mechanism includes a detection circuit configured to detect an actuation parameter and to generate a primary trigger signal based, at least in part, on the actuation parameter, wherein the electronic safety mechanism is configured to transition from the disengaged configuration to the engaged configuration responsive to generation of the primary trigger signal, and further wherein the detection circuit includes:
(i) a detection circuit controller, which is programmed to control operation of the detection circuit; and
(ii) a supervisory circuit, which is configured to verify proper operation of the detection circuit controller.

2. The power tool of claim 1, wherein the electronic safety mechanism further includes:
(i) a reaction circuit configured to receive the primary trigger signal and to generate a transition motive force responsive to receipt of the primary trigger signal; and
(ii) a mechanical reaction mechanism configured to mechanically transition the electronic safety mechanism from the disengaged configuration to the engaged configuration responsive to receipt of the transition motive force.

3. (canceled)

4. The power tool of claim 2, wherein the reaction circuit includes a reaction circuit controller programmed to control operation of the reaction circuit.

5. The power tool of claim 2, wherein the reaction circuit includes a trigger circuit and an electro-mechanical actuator, wherein the trigger circuit is configured to receive at least one of the primary trigger signal and a secondary trigger signal and to provide a trigger electric current to the electro-mechanical actuator responsive to receipt of the at least one of the primary trigger signal and the secondary trigger signal.

6. The power tool of claim 5, wherein the electro-mechanical actuator is configured to generate the transition motive force responsive to receipt of the trigger electric current.

7. The power tool of claim 5, wherein the reaction circuit further includes an electric current source configured to generate the trigger electric current and to provide the trigger electric current to the trigger circuit.

8. The power tool of claim 5, wherein the supervisory circuit is configured to monitor operation of at least one other component of the detection circuit and to generate the secondary trigger signal responsive to determining that the at least one other component of the detection circuit is in a corresponding fault state.

9-12. (canceled)

13. The power tool of claim 2, wherein the mechanical reaction mechanism includes a braking assembly configured to stop the driven motion of the implement holder responsive to receipt of the transition motive force.

14. The power tool of claim 13, wherein the braking assembly includes at least one of:
(i) a friction assembly configured to apply a frictional force to stop the driven motion of the implement holder;
(ii) a brake shoe;
(iii) a brake pad;
(iv) a brake drum; and
(v) a brake rotor.

15. (canceled)

16. The power tool of claim 1, wherein the detection circuit includes a capacitive sensor assembly configured to detect the actuation parameter.

17. The power tool of claim 16, wherein the capacitive sensor assembly includes a capacitive interface, a signal drive circuit, which is configured to provide a drive signal to the capacitive interface, and a signal sense circuit, which is configured to receive a sense signal from the capacitive interface.

18. The power tool of claim 17, wherein the implement at least partially defines the capacitive interface.

19. The power tool of claim 17, wherein
the actuation parameter is based, at least in part, on at least one of:
(i) the drive signal;
(ii) the sense signal; and
(iii) a comparison between the drive signal and the sense signal.

20. The power tool of claim 17, wherein
the detection circuit controller is programmed to at least one of:
(i) provide a drive control signal to the signal drive circuit, wherein the drive signal is based, at least in part, on the drive control signal;
(ii) provide a drive diagnostic signal to the signal drive circuit, wherein the detection circuit controller further is programmed to utilize the drive diagnostic signal to verify proper operation of the signal drive circuit;
(iii) receive a sense control signal from the signal sense circuit, wherein the actuation parameter is based, at least in part, on the sense control signal; and
(iv) receive a sense diagnostic signal from the signal sense circuit, wherein the detection circuit further is programmed to utilize the sense diagnostic signal to verify proper operation of the signal sense circuit.

21. The power tool of claim 1, wherein the detection circuit controller is programmed to generate the primary trigger signal when the actuation parameter is indicative of an undesired predetermined condition.

22. The power tool of claim 21, wherein the undesired predetermined condition includes at least one of:
(i) an undesired event to be avoided with the power tool;
(ii) a kickback parameter indicative of a potential for kickback of the power tool;
(iii) a movement parameter indicative of an undesired movement of the power tool; and
(iv) a proximity parameter indicative of a distance between an individual and the implement being less than a threshold distance.

23. The power tool of claim 1, wherein the detection circuit controller is programmed to determine that the power tool is in a predetermined operating configuration and to generate a motor engage signal responsive to determining that the power tool is in the predetermined operating configuration, wherein the power tool is configured to permit the motor to generate the motive force responsive to generation of the motor engage signal.

24. The power tool of claim 1, wherein the supervisory circuit is positioned within a supervisory circuit electronic package, and further wherein the detection circuit controller is positioned within a detection circuit controller electronic package that is spaced apart from the supervisory circuit electronic package.

25. The power tool of claim 1, wherein the supervisory circuit includes a supervisory microcontroller, and further wherein the detection circuit controller is a detection circuit microcontroller that is distinct from the supervisory microcontroller.

26. The power tool of claim 1, wherein the supervisory circuit includes at least one of a logic circuit, a voltage detection circuit, and a frequency detection circuit.

27-32. (canceled)
